(19) United States
(12) Patent Application Publication
(10) Pub. No.: US 2022/0179579 A1
(43) Pub. Date: Jun. 9, 2022

(54) MONITORING PERFORMANCE OF REMOTE DISTRIBUTED STORAGE

(71) Applicant: EXFO Solutions SAS, Saint-Jacques-de-la-Lande (FR)

(72) Inventor: Benjamin BERTEAUX, Mordelles (FR)

(21) Appl. No.: 17/114,813

(22) Filed: Dec. 8, 2020

(51) Int. Cl. G06F 3/06

(52) U.S. Cl. CPC G06F 3/0653; G06F 3/0604; G06F 3/0647; G06F 3/067

(57) ABSTRACT

There is provided a test method designed to test the performance of a remote distributed storage from a compute node perspective. The test method can be embodied by a test tool, e.g., in the form of a bash script, which can provide indicators of the actual performance faced by compute jobs running on a compute node. The test method can be used to determine if the storage write or read throughput is stable or experiences some critical drops.

### TECHNICAL FIELD

The present description generally relates to storage performance monitoring, and more particularly to monitoring the performance of remote distributed storage.

### BACKGROUND

With the development of distributed data storage technology, a data storage system is no longer limited to being locally deployed on a single storage device but may be disposed at any physical location that is accessible to a user or compute node, via a network. Storage may be virtualized and spread in a cloud environment, through which it is made accessible by compute nodes even though the compute nodes do not have direct access via the physical layer. In a distributed data storage system, data processing is not limited to being implemented on a single device. Large data objects may be divided into small data blocks and then stored on multiple storage devices. Small data blocks may be processed on local compute node. Each small data block may be processed at a corresponding compute node, and then the processed result of each small data block may be integrated into a final result.

Microsoft Azure is an example of such cloud environment where storage is virtualized and spread in the Microsoft cloud.

Some tools exist to monitor storage performance. However, monitoring storage in a cloud environment can be quite challenging. Some cloud environment services gather some statistics on the storage layer's health, but that does not always reflect actual performances from a compute node point of view because several elements might degrade the experience and not trigger an alert (network congestion, driver issue, cache mechanisms, etc.).

There therefore remains a need for a test method that allows for monitoring the storage performance from a compute node perspective and/or provide performance indicators that are representative of the storage performance faced by a compute job running on a compute node.

### SUMMARY

There is therefore provided a test method designed to test the performance of a remote distributed storage from a compute node perspective. The test method can be embodied by a test tool, e.g., in the form of a bash script, which can provide indicators of the actual performance faced by compute jobs running on a compute node. The test method can be used to determine if the storage write or read throughput is stable or experiences some critical drops.

The method allows to monitor storage performance from a compute node perspective, such as an Azure node for example. The test results provide an actual representation of performances as they are monitored from a compute node.

In accordance with one aspect, there is provided a computer-implemented method for monitoring a storage throughput from a local compute node to a remote distributed storage, the method comprising:

creating a data file in random-access memory of the local compute node;
launching a command to copy the data file from the random-access memory to the remote distributed storage and recording a duration of the copy;
deriving and outputting a value of a write throughput from the recorded duration; and
repeating the steps of launching, recording and deriving multiple times.

In accordance with another aspect, there is provided a computer-implemented method for monitoring a storage read throughput from a compute node, the method comprising:

creating a data file at the local compute node;
launching a command to write the data file to the remote distributed storage;
once the write is completed, launching a command to copy the data file from the remote distributed storage to a random-access memory of the local compute node and recording a duration of the copy; and
deriving and outputting a value of a read throughput from the recorded duration; and
repeating the steps of launching, recording and deriving multiple times.

In accordance with yet another aspect, there is provided a non-transitory computer-readable storage medium comprising instructions that, when executed, cause a processor to perform the steps of:

creating a data file in random-access memory of the local compute node;
launching a command to copy the file from the random-access memory to the remote distributed storage and recording a duration of the copy;
deriving and outputting a value of a write throughput from the recorded duration; and
repeating multiple times, the steps of launching, recording and deriving.

Further features and advantages of the present invention will become apparent to those of ordinary skill in the art upon reading of the following description, taken in conjunction with the appended drawings.

### BRIEF DESCRIPTION OF THE DRAWINGS

FIG. 1 is a block diagram illustrating an example architecture of a computer system or server embodying the compute node from which read and write performances are to be tested, in accordance with one embodiment.

FIG. 2 is a flowchart illustrating a method for monitoring a write throughput from the compute node to a remote distributed storage, in accordance with one embodiment.

FIG. 3 is a flowchart illustrating a method for monitoring a read throughput from the compute node to a remote distributed storage, in accordance with one embodiment.

FIG. 4 comprises FIG. 4A and FIG. 4B and shows an example implementation of the methods of FIGS. 2 and 3 in the form of bash script.

It will be noted that throughout the drawings, like features are identified by like reference numerals. To not unduly encumber the figures, some elements may not be indicated in some figures if they were already identified in a preceding figure. It should be understood herein that elements of the drawings are not necessarily depicted to scale. Some mechanical or other physical components may also be omitted in order to not encumber the figures.

The following description is provided to gain a comprehensive understanding of the methods, apparatus and/or systems described herein. Various changes, modifications, and equivalents of the methods, apparatuses and/or systems described herein will suggest themselves to those of ordinary skill in the art. Description of well-known functions and structures may be omitted to enhance clarity and conciseness.

Although some features may be described with respect to individual exemplary embodiments, aspects need not be limited thereto such that features from one or more exemplary embodiments may be combinable with other features from one or more exemplary embodiments.

### DETAILED DESCRIPTION

The test tool that is used to implement the herein-described methods resides on and runs on a compute node, which in one embodiment, resides in a cloud environment.

For example, without limitation, the tested cloud environment may comprise Microsoft Azure where storage is virtualized and spread in the Microsoft cloud using Apache Hadoop and the Hadoop Distributed File System (HDFS). The test method may still be used on any cloud platform to monitor storage performance from a Hadoop node or any other node convention.

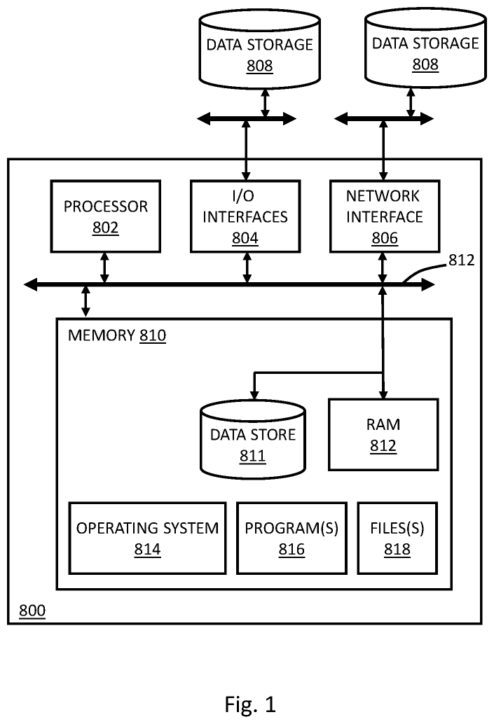

Now referring to the drawings, FIG. 1 is a block diagram of a computer system or server 800 which may embody the compute node from which the test tool is ran. The compute node interacts with a remote distributed storage, which in one embodiment, resides in a cloud environment.

For example, without limitation, the cloud environment may comprise Microsoft Azure where storage is virtualized and spread in the Microsoft cloud and may be implemented using Apache Hadoop and the Hadoop Distributed File System (HDFS).

In terms of hardware architecture, the computer system 800 generally includes a processor 802, input/output (I/O) interfaces 804, a network interface 806, and memory 810 comprising a data store 811 and a random-access memory (RAM) 810. The computer system 800 may interact with one or more remote data storage 808 of a distributed storage. It should be appreciated by those of ordinary skill in the art that FIG. 1 depicts the computer system 800 in a simplified manner, and a practical embodiment may include additional components and suitably configured processing logic to support known or conventional operating features that are not described in detail herein.

A local interface 812 interconnects the major components. The local interface 812 may be, for example, but not limited to, one or more buses or other connections, as is known in the art. The local interface 812 may have additional elements, which are omitted for simplicity, such as controllers, buffers (caches), drivers, repeaters, and receivers, among many others, to enable communications. Further, the local interface 812 may include address, control, and/or data connections to enable appropriate communications among the aforementioned components.

The computer system 800 is controlled by the processor 802, which serves as the central processing unit (CPU) for the system. The processor 802 is a hardware device for executing software instructions. The processor 802 may comprise one or more processors, including central processing unit(s) (CPU), auxiliary processor(s) or generally any device for executing software instructions. When the computer system 800 is in operation, the processor 802 is configured to execute software stored within the memory 810, to communicate data to and from the memory 810, and to generally control operations of the computer system 800 pursuant to the software instructions. The I/O interfaces 804 may be used to receive user input from and/or for providing system output to one or more devices or components. I/O interfaces 804 may include, for example, a serial port, a parallel port, a Small Computer System Interface (SCSI), a Serial ATA (SATA), a fibre channel, Infiniband, iSCSI, a PCI Express interface (PCI-x), an Infrared (IR) interface, a Radio Frequency (RF) interface, a Universal Serial Bus (USB) interface, or the like.

The data store 811 may be used to store data. The data store 811 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 811 may incorporate electronic, magnetic, optical, and/or other types of storage media. In one example, the data store 811 may be located internal to the computer system 800 such as, for example, an internal hard drive connected to the local interface 812 in the computer system 800. The RAM 812 may include any volatile memory elements (e.g., random access memory (RAM, such as DRAM, SRAM, SDRAM, and the like)) and/or nonvolatile RAM elements.

The network interface 806 may be used to enable the computer system 800 to communicate over a computer network or the Internet. The network interface 806 may include, for example, an Ethernet card or adapter or a Wireless Local Area Network (WLAN) card or adapter. The network interface 806 may include address, control, and/or data connections to enable appropriate communications on the network. The network interface 806 may be used to connect to data storage 808 through a network, such as, for example, a network attached file server or a cloud environment.

The data storage 808 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the data storage 808 may incorporate electronic, magnetic, optical, and/or other types of storage media. The data storage 808 may have a distributed architecture, where various components are situated remotely from one another, but can be accessed by the processor 802.

The memory 810 may be used to save software and/or files. The software in memory 810 may include one or more computer programs, each of which includes an ordered listing of executable instructions for implementing logical functions. The software in the memory 810 includes a suitable operating system (O/S) 814 and one or more computer programs 816. The operating system 814 essentially controls the execution of other computer programs, such as the one or more programs 816, and provides scheduling, input-output control, file and data management, memory management, and communication control and related services. The one or more programs 816 may be configured to implement the various processes, algorithms, methods, techniques, etc. described herein. File(s) 818 saved or stored in memory 810 may include data to be processed by the processor 802, results of the processed data, test files or the like.

It should be noted that the architecture of the computer system as shown in FIG. 1 is meant as an illustrative example only. Numerous types of computer systems are available and can be used to implement the computer system.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions such as a program or a script, executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

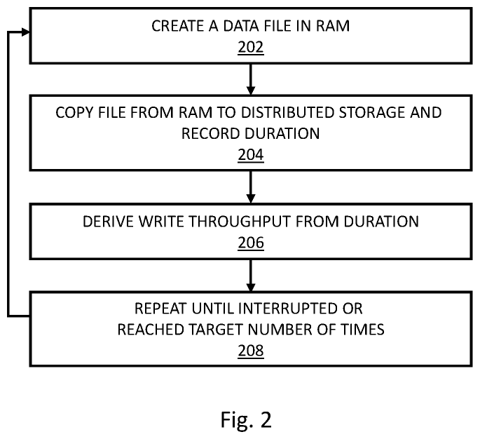

FIG. 2 is a flowchart illustrating a method for monitoring a write throughput from a compute node to a remote distributed storage. The method may be embodied by a script which resides and runs on the compute node.

In step 202, a test data file of a given file size is created in RAM of the local compute node. For example, a file of 1 GB, 5 GB or 10 GB can be used. It is noted that larger file sizes may allow to measure a throughput value that is more representative of the actual remote storage performance. However, care should be taken not to saturate the RAM because RAM saturation could lead to system crash, performance degradation or test file corruption. The file size should thus be small enough to ensure that the necessary memory for saving the file is and remains available in local RAM during the execution of the test, and this without saturating the RAM for other services on the compute node (i.e., operating system, running applications, etc.).

In step 204, a command to copy the file from the RAM to the remote distributed storage is launched and a duration of the copy is monitored and recorded;

In step 206, a value of the write throughput is derived from the recorded duration. The result may be displayed on screen and/or recorded in a result file (throughput=file size/duration).

In step 208, these steps are repeated until the process is interrupted, until a predetermined number of times is reached or for a given time lapse. For example, the test process can be repeated in loop for 1, 12 or 24 hours.

In some embodiments, a graph representing the write throughput as a function of time may be output for a user to assess a stability of the write throughput as well as any critical drops in write throughput.

It is noted that copying the test data file from the local RAM (instead, e.g., from the hard drive) allows to get around any performance issues or latencies that could arise from the hard drive and allows the test to better represent the distributed storage performance.

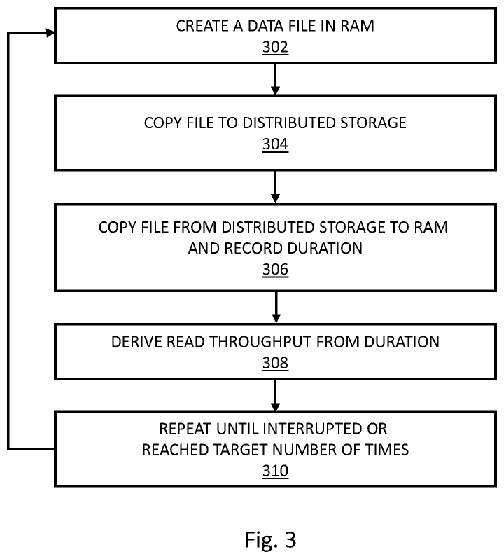

FIG. 3 is a flowchart illustrating a method for monitoring a read throughput from a remote distributed storage to the compute node. Again, the method may be embodied by a script which resides on and runs on the compute node.

In step 302, a test data file of a given file size is created at the local compute node. For example, a file of 1 GB, 5 GB or 10 GB can be used. The file can be created in RAM although this is not critical for read throughput testing and could be created on a hard drive as well. The above-noted constraints concerning the file size also applies here (see step 202 above).

In step 304, a command to copy the file to the remote distributed storage is launched.

In step 306, a command to copy the file from the remote distributed storage to the local RAM is launched and a duration of the copy is monitored and recorded.

In step 308, a value of the read throughput is derived from the recorded duration. The result may be displayed on screen and/or recorded in a result file (throughput=file size/duration).

In step 310, these steps are repeated until the process is interrupted, until a predetermined number of times is reached or for a given time lapse. For example, the test process can be repeated in loop for 1, 12 or 24 hours.

In some embodiments, a graph representing the read throughput as a function of time may be output for a user to assess a stability of the read throughput as well as any critical drops in read throughput.

Of course, some steps of the methods of FIGS. 2 and 3 may be combined so as to record both read and write throughputs.

It is noted that copying the test data file to the local RAM (instead, e.g., to the hard drive) allows to get around any performance issues or latencies that could arise from the hard drive and allows the test to better represent the distributed storage performance.

In some embodiments, the file copy commands may be implemented using Hadoop command lines.

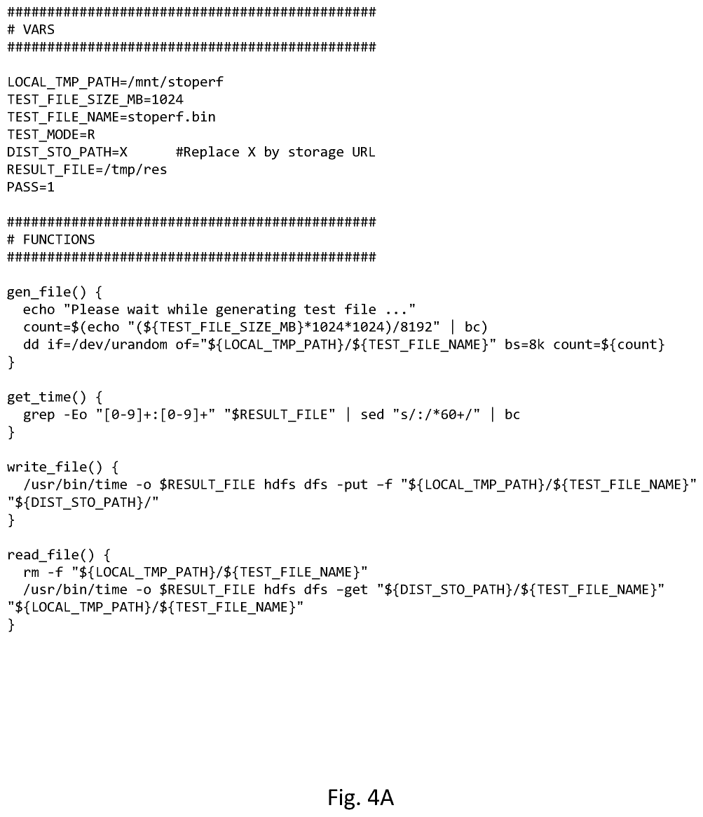

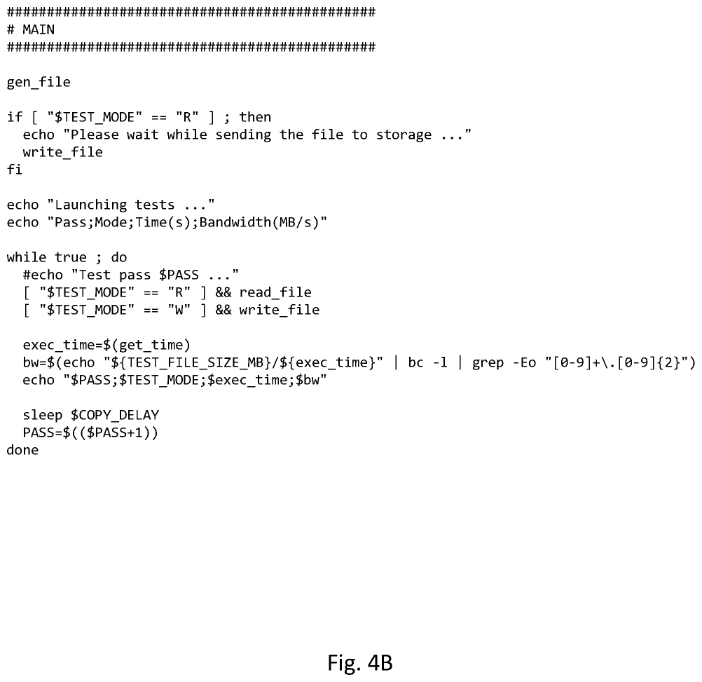

FIG. 4, which comprises FIG. 4A and FIG. 4B shows an example implementation of the methods of FIGS. 2 and 3 in the form of a bash script which allows to test both write and read throughputs of a distributed storage from a compute node. The script uses Hadoop command lines (hdfs) to read and write from the distributed storage.

Of note is that prior to running the script of FIG. 4, a ram disk should be created in the local RAM, i.e., a directory for storing files such as the test data file. The size of the ram disk should be at least that of the test data file. For example, the following command may be used to create a ram disk with file path “/mnt/stoperf”.

mount -t tmpfs -o size=1500 M tmpfs/mnt/stoperf

Of course, the test tool may be implemented in other computer environments and is not limited to the Microsoft Azure environment and may alternatively be written in whatever other computer language is suitable for the environment in which the tool is to be used.

The embodiments described above are intended to be exemplary only. The scope of the invention is therefore intended to be limited solely by the appended claims.

1. A computer-implemented method for monitoring a storage throughput from a local compute node to a remote distributed storage, the method comprising:
creating a data file in random-access memory of the local compute node;
launching a command to copy the data file from the random-access memory to the remote distributed storage and recording a duration of the copy;
deriving and outputting a value of a write throughput from the recorded duration; and
repeating the steps of launching, recording and deriving multiple times.

2. The method as claimed in claim 1, wherein the steps of launching, reading and deriving are repeated until interrupted.

3. The method as claimed in claim 1, wherein the steps of launching, reading and deriving are repeated for a predetermined number of times.

4. The method as claimed in claim 1, wherein the steps of launching, reading and deriving are repeated over a given time lapse.

5. The method as claimed in claim 1, further comprising:
launching a command to copy the data file from the remote distributed storage to the random-access memory and recording a duration of the copy;
deriving and outputting a value of a read throughput from the recorded duration; and
repeating the steps of launching, recording and deriving multiple times.

6. The method as claimed in claim 1, further comprising: creating a ram disk in the random-access memory of the local compute node to create said data file.

7. The method as claimed in claim 1, wherein the remote distributed storage is a virtual distributed storage reached via a cloud environment.

8. The method as claimed in claim 6, wherein the cloud environment is Microsoft Azure and wherein the compute node is an Azure node.

9. A computer-implemented method for monitoring a storage read throughput from a compute node, the method comprising:
creating a data file at the local compute node;
launching a command to write the data file to the remote distributed storage;
once the write is completed, launching a command to copy the data file from the remote distributed storage to a random-access memory of the local compute node and recording a duration of the copy; and
deriving and outputting a value of a read throughput from the recorded duration; and
repeating the steps of launching, recording and deriving multiple times.

10. The method as claimed in claim 9, wherein the steps of launching, reading and deriving are repeated until interrupted.

11. The method as claimed in claim 9, wherein the steps of launching, reading and deriving are repeated for a predetermined number of times.

12. The method as claimed in claim 9, wherein the steps of launching, reading and deriving are repeated over a given time lapse.

13. The method as claimed in claim 9, further comprising: creating a ram disk in the random-access memory of the local compute node to copy said data file.

14. A non-transitory computer-readable storage medium comprising instructions that, when executed, cause a processor to perform the steps of:
creating a data file in random-access memory of the local compute node;
launching a command to copy the file from the random-access memory to the remote distributed storage and recording a duration of the copy;
deriving and outputting a value of a write throughput from the recorded duration; and
repeating multiple times, the steps of launching, recording and deriving.

15. The non-transitory computer-readable storage medium as claimed in claim 14, wherein the instructions cause the processor to repeat the steps of launching, reading and deriving are repeated until interrupted.

16. The non-transitory computer-readable storage medium as claimed in claim 14, wherein the instructions cause the processor to repeat the steps of launching, reading and deriving are repeated for a predetermined number of times.

17. The non-transitory computer-readable storage medium as claimed in claim 14, wherein the instructions cause the processor to repeat the steps of launching, reading and deriving are repeated over a given time lapse.

18. The non-transitory computer-readable storage medium as claimed in claim 14, further comprising instructions that, when executed, cause the processor to perform the steps of:
launching a command to copy the file from the remote distributed storage to the random-access memory and recording a duration of the copy;
deriving and outputting a value of a read throughput from the recorded duration; and
repeating the steps of launching, recording and deriving multiple times.

19. The non-transitory computer-readable storage medium as claimed in claim 14, further comprising instructions that, when executed, cause the processor to perform the step of: creating a ram disk in the random-access memory of the local compute node to copy said data file.
